(19) United States
(12) Patent Application Publication
(10) Pub. No.: US 2024/0243838 A1
(43) Pub. Date: Jul. 18, 2024

(54) SYSTEMS AND METHODS FOR ADAPTIVE TRANSMIT SIGNAL QUALITY

(71) Applicant: Telefonaktiebolaget LM Ericsson (publ), Stockholm (SE)

(72) Inventors: Hamed FARHADI, Stockholm (SE); Mårten SUNDBERG, Årsta (SE); Muhammad Ali KAZMI, Sundbyberg (SE); Henrik RYDÉN, Stockholm (SE)

(21) Appl. No.: 18/576,063

(22) PCT Filed: Jul. 1, 2022
(86) PCT No.: PCT/SE2022/050667

§ 371 Date: Jan. 2, 2024

Related U.S. Application Data
(60) Provisional application No. 63/217,810, filed on Jul. 2, 2021.

(51) Int. Cl. H04L 1/00; H04B 1/04

(52) U.S. Cl. CPC H04L 1/0025; H04B 1/0475

(57) ABSTRACT

A method by a transmitting node for adapting a transmission mode based on a capability of a receiving node includes obtaining information indicating a capability of the receiving node to receive signals having a certain level of distortion. The transmitting node transmits a signal to the receiving node, the signal transmitted using a transmission mode selected based on the capability of the receiving node.

### TECHNICAL FIELD

The present disclosure relates, in general, to wireless communications and, more particularly, systems and methods for adaptive transmit signal quality.

### BACKGROUND

Power amplifier (PA) back-off is a mechanism to adjust the operating point of a PA such that the distortion of the signal due to PA non-linearity can be within a certain target. Examples include constraints on error vector magnitude (EVM) for in-band distortion and constraints on adjacent carrier leakage ratio (ACLR) for out of band (OOB) emissions. For given transmit signal parameters, these may include, for example, a selected modulation and coding scheme (MCS) index.

There are other means to linearize the PA, such as using pre-distortion in the digital domain. This is called digital pre-distortion (DPD). Such a scheme will typically make the PA operation more linear but will not remove non-linear effects when transmitting with a low back-off. A feedback-loop is typically used in such a scenario such that the DPD is designed based on the signal coming into the PA and the signal that is fed back after the PA.

The overall impairments imposed on a signal at the transmitter or receiver are typically measured using distortion measures such as EVM in New Radio (NR). Such impairments can come from the abovementioned power-amplified non-linearities but also from other effects, such as phase noise, In-phase and Quadrature (I/Q) gain and phase imbalance, unwanted Direct Current (DC) levels, and Digital-Analog-Converter (DAC) noise.

Because throughput fluctuates with varying EVM, 3GPP specifications impose requirements for the largest values of EVM that can be tolerated. For example, Table 1 lists required EVM values as disclosed in 3GPP TS 38.104 V17.1.0 and demonstrates that lower constellation orders can tolerate higher impairment levels.

TABLE
EVM requirements for BS

| Modulation scheme for PDSCH | Required EVM (%) |
|---|---|
| QPSK | 17.5% |
| 16QAM | 12.5% |
| 64QAM | 8% |
| 256QAM | 3.5% |

There are also requirements imposed on other kinds of effects such as those from hardware impairment. Such requirements may apply to out of band (OOB) distortions such as for instance Adjacent Channel Leakage Ratio (ACLR) and Intermodulation Distortion (IMD), as disclosed in 3GPP TS 38.104 V17.1.0. Specifically, ACLR is the ratio of the filtered mean power centered on the assigned channel frequency to the filtered mean power centered on an adjacent channel frequency and is discussed in section 6.6.3 of 3GPP TS 38.104 V17.1.0 (conducted measurements) and 9.7.3 of 3GPP TS 38.104 V17.1.0 (radiated measurements, due to the increase in frequency and the new antenna architectures expected in these regions). A summary of the ACLR requirements for a base station (BS) is provided in Table 2.

TABLE 2
ACLR requirements

| Frequency range [GHz] | ACLR requirement [dB] |
|---|---|
| Up to 6 | 45 |
| 24.25-33.4 | 28 |
| 37-52.67 | 26 |

As can be seen from Table 1, the requirements diminish as frequency increases, indicating that, if frequency operations increase even further, an even more relaxed requirements could be expected.

### Machine Learning:

Machine learning algorithms refer to techniques that use a set of data for training models, which are used for various applications including, for example, classification and regression on, new, unseen data. When deploying a model to perform inference on new data, the machine learning algorithms can be classified into online and offline algorithms. The offline algorithms rely on pre-trained models while the online algorithms can train the model on the fly while receiving new data samples.

There currently exist certain challenge(s), however. For example, in existing networks, the PA back-off is applied to lower transmit power and, thus, reduce the distortion due to PA non-linearities. This results in improved data detection at the receiver and reduced out of-band emission. However, though the PA back-off leads to lower signal distortion, the PA operates with lower energy efficiency and lower output transmit power. In downlink scenarios, the lower energy efficiency of the PA at the transmitter side (i.e., base station) implies more energy consumption, higher heat dissipation, heavier heat sink, and bulky radio units. In uplink (UL) scenarios, the lower energy efficiency of the PA at the transmitter side (i.e., user equipment) implies more energy consumption and reduced battery lifetime of the device. Also, the reduced output level of the PA reduces the coverage in both uplink (UL) and downlink (DL) scenarios.

During the last several decades, carrier frequency of r cellular systems has increased. Specifically, 2G mainly operated within a range of 400 MHZ-2 GHZ. 3G and 4G expanded the operation to around 4 GHz. 5G/NR now defines frequency operation up to 52.6 GHz and currently also specifies the operation to around 70 GHz. From a PA implementation perspective, the increase in frequency operation typically comes at a cost of decreased output power and reduced energy efficiency and, if integrating the PA onto the chip, a more limited ability of a feedback-based linearization.

Increasing the frequency range has mainly been motivated by the scarcity of available spectrum at lower frequency ranges. Thus, when also operating at higher frequencies, a wider bandwidth allocation is expected. This poses additional challenges to the DPD that typically operates at a sampling rate well exceeding the transmission bandwidth in order to linearize the out-of-band emissions.

Further, DPD has been mainly considered a solution at network node for linearization of the transmit signal. It has been less adopted at the device side due to the considerations regarding the device's cost and energy consumption. Thus, there would be limited capability at the transmit side in UL transmission to linearize the PA and to reduce the distortions due to PA nonlinearities. The existing trends toward transmission at higher frequency, lower energy efficiency, rising challenges to linearize PA operation and lower output power of PAs at higher frequency highlight the need for developing techniques that rely on applying minimum possible PA back-off.

### SUMMARY

Certain aspects of the disclosure and their embodiments may provide solutions to these or other challenges. For example, methods and systems are provided that enable the transmitting node and/or receiving node to adjust the quality of modulated signal while meeting the regulatory emission requirements according to the capability of the receiver to detect signals with degraded modulation quality (e.g. higher EVM) and/or the capability of the transmitter to adjust a level of distortion associated with the signals.

According to certain embodiments, a method by a transmitting node for adapting a transmission mode based on a capability of a receiving node includes obtaining information indicating a capability of the receiving node to receive signals having a certain level of distortion. The transmitting node transmits a signal to the receiving node. The signal transmitted using a transmission mode selected based on the capability of the receiving node.

According to certain embodiments, a transmitting node for adapting a transmission mode based on a capability of a receiving node is provided. The transmitting node is adapted to obtain information indicating a capability of the receiving node to receive signals having a certain level of distortion. The transmitting node is adapted to transmit a signal to the receiving node. The signal transmitted using a transmission mode selected based on the capability of the receiving node.

According to certain embodiments, a method by a receiving node for adapting a reception mode based on a capability of a transmitting node includes obtaining information indicating the capability of the transmitting node to adjust a transmit mode to transmit signals having a certain level of distortion. The receiving node receives a signal from the transmitting node. The signal transmitted using a transmission mode selected based on the capability of the transmitting node. According to certain embodiments, a receiving node for adapting a reception mode based on a capability of a transmitting node is provided. The receiving node is adapted to obtain information indicating the capability of the transmitting node to adjust a transmit mode to transmit signals having a certain level of distortion. The receiving node is adapted to receive a signal from the transmitting node. The signal transmitted using a transmission mode selected based on the capability of the transmitting node.

Certain embodiments may provide one or more of the following technical advantage(s). For example, certain embodiments may provide a technical advantage of enabling a transmitter to improve energy efficiency by operating at an operating point that allows for a lower quality of the transmit signal when possible. For example, in certain embodiments, the PA can operate at a more nonlinear operating point, thus improving the energy efficiency of the transmitter when the receiver has capability to compensate for PA nonlinearities.

As another example, certain embodiments may provide a technical advantage of enabling the PA to operate at higher transmit power when possible, thus improving the coverage of the transmitter in the cell.

As further examples, certain embodiments deployed in a downlink scenario such as where the PA is at the base station (BS) may provide one or more of the following technical advantages:
enabling more nonlinear PA operation and higher distortions due to RF impairments (e.g. phase noise) at BS;
increasing energy efficiency of BS;
reducing the requirements on DPD at BS and, thus, reducing the energy requirements for digital processing at baseband;
lowering heat dissipation at BS;
providing smaller BS radio units due to reducing the requirements on heat sinks; and/or
enhancing DL coverage/throughput.

As still other examples, certain embodiments deployed in an uplink scenario such as where the PA is at the user equipment (UE) may provide one or more of the following technical advantages:
enabling more nonlinear PA operation and higher distortions due to RF impairments (e.g. phase noise) at UE;
reducing energy consumption at UE;
providing longer UE battery lifetime; and
enhancing UL coverage/throughput.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a first example signaling diagram for a scenario when a receiving node (Rx node) is the controlling node, according to certain embodiments

FIG. 2 illustrates an example signaling diagram for a scenario when the transmitting node (Tx node) is the controlling node, according to certain embodiments;

FIG. 3 illustrates another example signaling diagram for a scenario when the Tx node 110 is the controlling node, according to certain embodiments;

FIG. 4 illustrates another example signaling diagram for a scenario when the Tx node is the controlling node, according to certain embodiments

FIG. 5 illustrates a flow diagram where a Tx node can adapt the PA back-off based on the feedback from the Rx node, according to certain embodiments;

FIG. 6 illustrates an example communication system, according to certain embodiments;

FIG. 7 illustrates an example UE, according to certain embodiments;

FIG. 8 illustrates an example network node, according to certain embodiments;

FIG. 9 illustrates a block diagram of a host, according to certain embodiments;

FIG. 10 illustrates a virtualization environment in which functions implemented by some embodiments may be virtualized, according to certain embodiments;

FIG. 11 illustrates a host communicating via a network node with a UE over a partially wireless connection, according to certain embodiments;

FIG. 12 illustrates a method by a Tx node for adapting a signal quality based on a capability of a Rx node, according to certain embodiments;

FIG. 13 illustrates a method by a Rx node for adapting signal quality based on a capability of a Tx node, according to certain embodiments; and

FIG. 14 illustrates a method by a Tx node for transmitting a signal quality based on a capability of the Tx node, according to certain embodiments

### DETAILED DESCRIPTION

Some of the embodiments contemplated herein will now be described more fully with reference to the accompanying drawings. Embodiments are provided by way of example to convey the scope of the subject matter to those skilled in the art. While many challenges can be seen in PA designs for higher frequencies, potential opportunities also arise. For example, with very wide bandwidth allocations, the need for a very spectral efficient operation diminishes. As such, using very high modulation orders may no longer be justified from an implementation perspective. As a result, this allows higher EVM, in general, as compared to operation at lower frequencies where modulations with higher orders would typically be used. As another example, the trend in reduced out-of-band emission requirements when increasing frequency would also allow for a more distorted signal at the transmitter.

According to certain embodiments, methods and systems are provided that enable the transmitting node and/or receiving node to adjust the quality of modulated signal while meeting the regulatory emission requirements according to the capability of the receiver to detect signals with degraded modulation quality (e.g. higher EVM) and/or the capability of the transmitter to adjust a level of distortion associated with the signals. Additionally and/or alternatively, more capable receivers such as, for example, ML-based receivers, can compensate the impact of the distortions due to RF hardware impairments such as PA nonlinearity by using advanced receiver algorithms such as digital post processing and/or ML demapping of the received signal. As a result, the receivers may be capable of tolerating more distortion in the received signal. Less back-off can be applied when the receiver is more capable of handling distortions which leads to more energy efficient operation of the transmitter.

In a particular embodiment, for example, the transmitter can adapt the transmit signal quality via adjusting PA back-off based on the feedback from the receiver regarding the receiver's capability to process and compensate the distortions, while meeting the regulatory requirements for OOB emissions.

To simplify description and different embodiments, the two different modes of operation are referred to as mode A and mode B respectively in the following descriptions:
Mode A: The transmitting node (Node1) operates according to a first set of requirements (S1) regarding quality of modulated signal, and emission requirements e.g. the node operates signal to meet S1 requirements for transmitted signals.
Mode B: The transmitting node (Node1) operates according to a second set of requirements (S2) regarding quality of modulated signal, and emission requirements e.g. the node meets S1 requirements for transmitted signals. The second set of requirements are looser (worse, more relaxed, less stringent etc.) than the requirements in operation A.

According to certain embodiments, the transmitting node (Node1) adapts between mode A and mode B operations based on the ability or status of the receiving node (Node2) for receiving signals with certain modulation quality (e.g., higher EVM) from Node1. For example:
if Node2 can receive signal transmitted by Node1 with modulation quality (Qm) worse than certain threshold (H) then the Node1 may transmit signals according to operational mode B or
if Node2 can receive only signal transmitted by Node1 with Qm equal to or better than H then the Node1 may transmit signals according to operational mode A.
The ability or status of Node2 may change over time e.g. dynamically, semi-statically etc.

In a particular embodiment, for example, the transmitting node lowers the quality of the modulated signal (i.e. goes into mode B of operation) according to a capability or status or ability of the receiver to handle signals with degraded modulation quality (e.g., higher EVM). Such transition into mode B can in one embodiment be activated by the receiving node.

In another particular embodiment, Qm is worse than H if EVM of signal transmitted by Node1 is above certain threshold (G1). In another example embodiment, Qm is worse than H if frequency error of signal transmitted by Node1 is above certain threshold (G2). In another example embodiment, Qm is equal to or better than H if EVM of signal transmitted by Node1 is equal to or below certain threshold (G1). In another example embodiment, Qm is equal to or better than H if frequency error of signal transmitted by Node1 is equal to or below certain threshold (G2).

According to certain embodiments, the adaptation between mode A and mode B operations of Node1 is controlled by Node2 such as, for example, via signaling. In another example embodiment, the adaptation between mode A and mode B operations of Node1 is performed according to one or more pre-defined rules such as, for example, based on signal quality, number of retransmissions, etc. In both cases, Node2 is capable of receiving signals from Node1 according to mode A and mode B operations.

The capability, ability, or status of Node2 may change over time (e.g. dynamically, semi-statically, etc.) due to receiver's resource adaptation.

In a particular embodiment, Node1 may determine the status of Node2 receiver implicitly (e.g., based on number of retransmissions, feedback signal such as Acknowledgment (ACK)/Non-Acknowledgment (NACK), etc.), and/or based on explicit indication (e.g., by receiving information from Node2 or from another node). The proposed methods, techniques, and solutions are described below in different embodiments. The different embodiments are treated differently depending on if the transmitting node (the node transmitting the signal in mode B) or the receiving node (the node receiving the signal transmitted in mode B) is the controlling node or not. Controlling node is here referred to as the node deciding the resource allocation, modulation and coding scheme, power level etc.

### The Receiving Node (Rx Node) as the Controlling Node

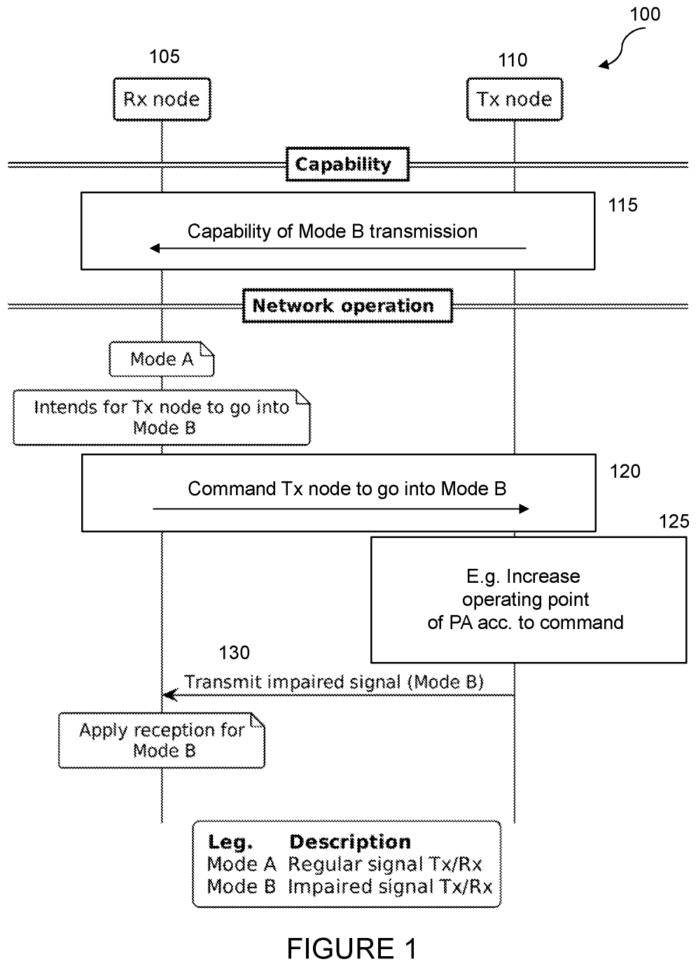

FIG. 1 illustrates a first example signaling diagram 100 for a scenario when the Rx node 105 is the controlling node, according to certain embodiments. Specifically, the Tx node 110, which may also be referred to as Node 1, may include the UE in an UL scenario or another UE in sidelink scenarios. The Rx node 105, which may also be referred to as Node 2, may include the BS in an UL scenario, the UE in a downlink scenario, or another UE in a sidelink scenario.

In the depicted signaling diagram 100, the Tx node 110 transmits, at 115, its capability for adapting signal transmission according to at least mode A and mode B operations. The Tx node capability information may be transmitted by the Tx node 110 to the Rx node 105 via signaling such as, for example, Downlink Control Information (DCI), Medium Access Control Control Element (MAC CE), Radio Resource Control (RRC), etc. Tx node 110 and Rx node 105 may also be referred to as Node1 and Node2, respectively.

As stated above, Tx node 110 indicates if it supports mode B operation in addition to mode A operation. For example, the capability indicates that the Tx node 110 can adapt transmission of signals between mode A and mode B operations. In different embodiments, this includes:
A single indicator of mode B common to all Tx nodes. Such operation might be defined in a specification text to include compliance to a relaxed set of requirements, for a given increased power level, as compared to mode A.
Different level of in-band signal quality (e.g., EVM) and out-of-band emissions (e.g., ACLR) the Tx node generates at different associated power levels.
The above Tx node's adaptive capability may be any one or more of:
   Static: In this case, the Tx node 110 can be configured to transmit signals with any of mode A and mode B operations at any time.
   Semi-static: In this case, Tx node 110 can be configured to transmit signals with any of mode A and mode B operations over a certain time period as indicated by Tx node. For example, Tx node 110 may be configured to transmit signals with any of mode A and mode B operations over the next N1 number of frames.
   Dynamic: In this case, the Tx node 110 can be configured to transmit signals with any of mode A and mode B operations over the next time resource such as for example, one or more slots, symbols, subframes, etc., as indicated by Tx node 110 via dynamic signaling such as, for example, via DCI, MAC CE, etc.

According to certain embodiments, the Rx node 105 includes a capability for adapting signal reception according to the mode A and mode B operations of Tx node 110. In a particular embodiment, the capability of the Rx node 105 may be transmitted to the Tx node 110 via signaling such as, for example, DCI, MAC CE, RRC, etc.

In a particular embodiment, for example, the capability indicates if Rx node 105 supports the reception of signals transmitted by Tx node 110 using mode B operation in addition to mode A operation. For example, the capability indicates that the Rx node 105 can adapt reception of signals between mode A and mode operations. A single indicator of mode B with associated allowed Tx parameter setting such as, for example, a certain level of Tx EVM allowed by the Tx node 110 in order for the Rx node 105 to comply with the performance requirements associated with mode B. In a particular embodiment, mode B may include different levels, which may include different sets of performance requirements to be fulfilled and/or different (sets of) allowed Tx parameters at the transmitter. In various particular embodiments, the above Node2's adaptive capability may be any one or more of:
Static: In this case, the Rx node 105 can be configured to receive signals transmitted from Tx node 110 according to any of mode A and mode B operations.
Semi-static: In this case, the Rx node 105 can be configured to receive signals from Tx node 110 transmitted according to any of mode A and mode B operations over a certain time period as indicated by Rx node 105 such as, for example, over the next M1 number of frames.
Dynamic: In this case, Rx node 105 can be configured to receive signals from Tx node 110 transmitted according to any of mode A and mode B operations over the next time resource such as, for example, one or more slots, symbols, subframes, etc., as indicated by Rx node 105 via dynamic signaling such as, for example, via DCI, MAC CE etc.

According to certain embodiments, the Rx node 105 controls the operation of Tx node 110 via signaling 120. For example, Rx node 105 that receives signals from Tx node 110 may control whether the Tx node 110 will transmit according to Mode A or mode B, as described below:
At 120, the Rx node 105 commands the Tx node 110 to enter mode B if operating in mode A or start with mode B otherwise. In different embodiments, the signaling may include one or more of:
   A control signaling message sent dynamically, e.g. using DCI
   A control signaling message sent semi-statically, e.g. using RRC signaling or MAC CE
   Such control message could indicate (one or a combination of the different embodiments below):
      The allowed MPR:
         The level can be related to requirements defined for Mode A of operation. For example, the Rx node 105 can signal ΔMPR and the Tx node 110 derives new MPR as follows:

$${MPR}_{new} = {MPR}_{Mode A} - Δ MPR .$$

The Rx node 105 can signal an integer (K) and the Tx node 110 derives new MPR as follows:
MPR_{new}=MPR_{Mode A}−K·ΔMPR where ΔMPR is pre-defined or configured and K=0, 1, 2, 3 etc is signaled. This allows the Rx node 105 to do MPR adjustment with different possible step sizes.
The allowed EVM:
   The allowed EVM can be signaled in absolute terms or in relative terms related to a pre-defined set of levels in a specification text, or to mode A operation, as outlined for MPR.
The power level to use (which in turn can be associated with certain requirements from the Tx node 110, see “Capability”).
At 125, the Tx node 110 adjusts the operating point of the transmitter such as for example, by increasing the transmit power. The Tx node 110 then transmits the impaired signal according to the control signaling, at 130.

According to certain other embodiments, the operation of Tx node 110 is adapted between Mode A and Mode B operations based on one or more pre-defined rules. In this case, Rx node 105 is capable of receiving signals transmitted by Tx node 110 according to mode A and mode B operations. For example, Tx node 110 may be pre-configured that Rx node 105 can receiving according to mode A and mode B operations. Examples of pre-defined rules may include one or more of:
In a particular embodiment, the adaptation between modes is based on number of retransmissions. For example, Tx node 110 is allowed to switch to mode B operation if the data block transmitted by Tx node 110 is successfully received by Rx node 105 with not more than K1 number of transmissions. Otherwise, Tx node 110 is required to operate according to mode A operation. In one example embodiment, K1=1. In another example embodiment, K1=4. In certain embodiments, the parameter K1 may be pre-defined or configured by Rx node 105.
In another particular embodiment, the adaptation between modes is based on signal level between Tx node 110 and Rx node 105. Examples of signal levels are signal strength (e.g., path loss, RSRP, etc.), signal quality (e.g., SINR, SNR, etc.). For example, in a particular embodiment, Tx node 110 is allowed to switch to mode B operation if the signal level is above certain threshold (e.g., SINR is above threshold). Otherwise, Tx node 110 is required to operate according to mode A operation. In certain embodiments, the parameter signal level threshold may be pre-defined or configured by Rx node 105.

According to certain embodiments, Tx node 110 may further indicate the mode of operation (e.g., mode A or mode B) being used by Tx node 110. In a particular embodiment, for example, Tx node 110 may indicate the mode of operation (e.g., mode A or mode B) being used by Tx node 110 when Tx node 110 switches the mode of operation. In another particular embodiment, for example, Tx node 110 may indicate the mode of operation only when Tx node 110 switches to or using mode B operation for transmitting signals to Rx node 105. When operating in Mode B, Tx node 110 may transmit signal using the allowed MPR according to the same principles as described above.

### The Tx Node as the Controlling Node

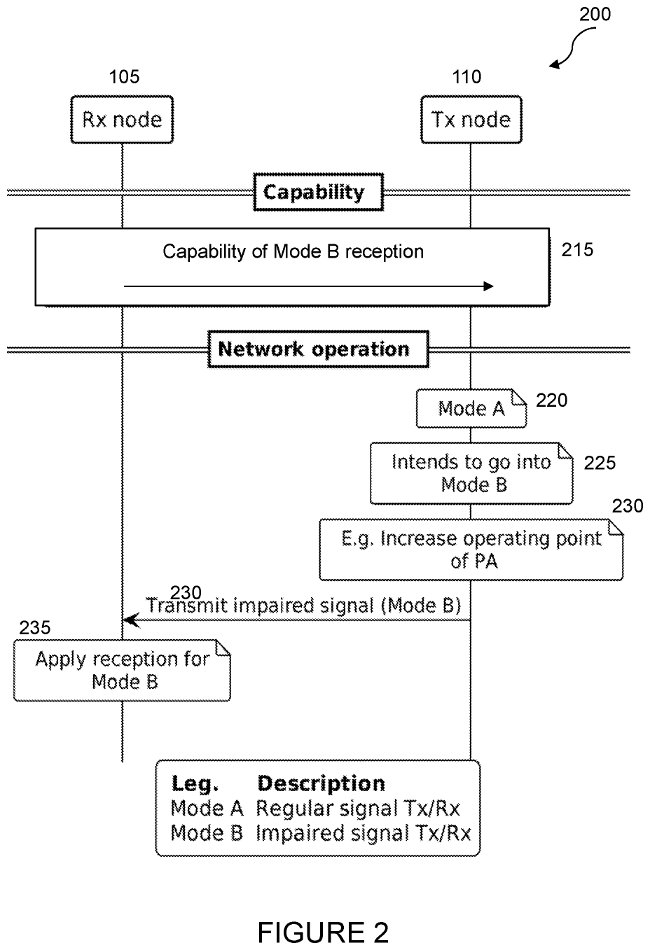

FIG. 2 illustrates an example signaling diagram 200 for a scenario when the Tx node 110 is the controlling node, according to certain embodiments. In the depicted signaling diagram 100, the Rx node 105 transmits, at 215, its capability for adapting signal reception according to at least mode A and mode B operations. For example, the Rx node 105 indicates if it supports mode B reception, in a particular embodiment. As will be described in more detail below, the Tx node 110 may also indicate if it supports mode B transmission, in a similar manner to that described above with regard to FIG. 1. In various particular embodiments, the Rx node capability information may be transmitted by the Rx node 105 to the Tx node 110 via signaling such as, for example, DCI, MAC CE, RRC, etc.

At step 220, Tx node 110 is operating in mode A and determines an intention to go into mode B at step 225.

In a particular embodiment, Tx node 110 increases the operating point of the PA, at step 230. The Tx node 110 then transmits the signal according to mode B, at step 235.

At step 240, the Rx node 105 applies reception for mode B.

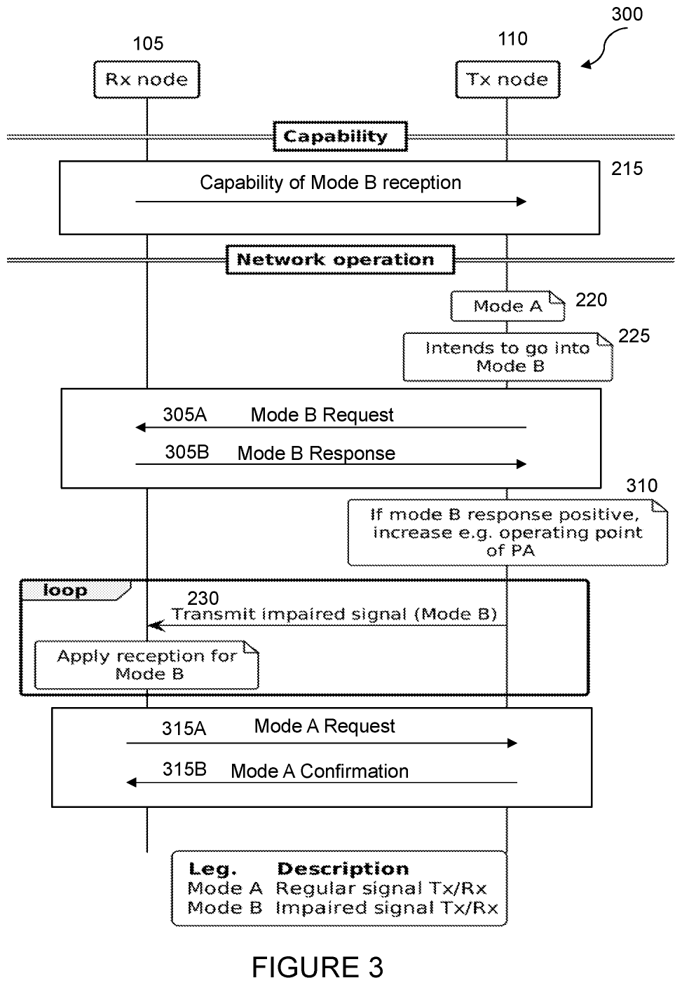

FIG. 3 illustrates an example signaling diagram 300 for a scenario when the Tx node 110 is the controlling node, according to certain embodiments. As depicted, the signaling of signaling diagram 300 is similar to that described above in FIG. 2 with like features being referred to with the same reference numerals. However, in the example of signaling diagram 300, Tx node 110 transmits a request to Rx node 105, at step 305. The request 305A requests Rx node 105 to receive signals from Tx node 110 according to mode B. Thereafter, at 305B, the Rx node 105 responds with acknowledgement or negative acknowledgement. Example reasons for the Rx node 105 not to acknowledge to go into mode B could be a low battery power (assuming mode B is more energy demanding), a current lack of available processing resources, a current lack of available memory resources, and a low signal quality (e.g., SINR below threshold). However, if the response at 305B is positive, the Tx node 110 increases an operating point of the transmitter, at step 310. For example, Tx node 110 may increase the operating point of the PA and then transmits the impaired signal in mode B.

At step 315A, if the Rx node 105 can no longer receive in mode B, the Rx node transmits a mode A request the Tx node 110, as the controlling node. At step 315B, the Tx node 110 transmits a mode A configuration and then adapts to mode A operation.

In this manner, network operation can switch between mode A and mode B operations based on signaling between the Rx node 105 and Tx node 110. As described above, any or all of such control signaling can be handled dynamically or semi-statically, using DCI, RRC, or MAC CE, in various embodiments.

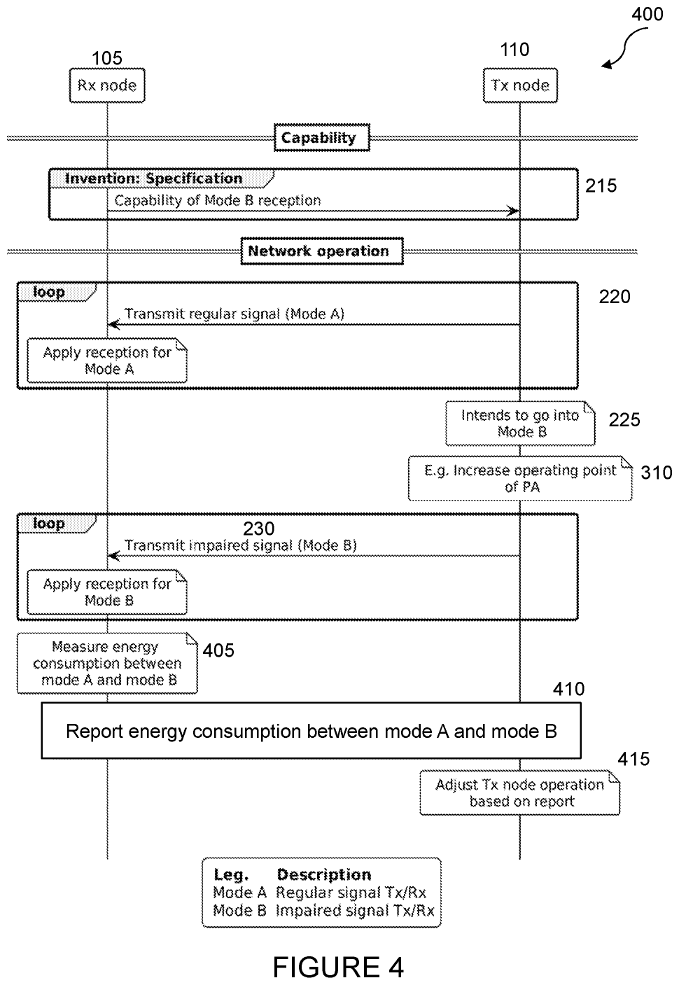

FIG. 4 illustrates another example signaling diagram 400 for a scenario when the Tx node 110 is the controlling node, according to certain embodiments. The depicted scenario can be implemented using the methodology described above with regard to FIG. 2 or 3. As such, like reference numerals are used to indicate signaling and steps similar to those described above. However, signaling diagram 400 includes an additional measurement step 405 for measuring the energy consumption at the Rx node 105.

At step 410, the Rx node 105 reports the energy consumption between mode A and mode B to the Tx node 110. Tx node 110 adjusts operation based on the report, at step 415.

In a particular embodiment, at step 410, the Rx node 105 indicates, for example, a relative metric between operation A and B. The Tx node 110 uses this information in order to adjust its operation such as, for example, when to enter mode A or mode B for the Tx node 110.

In another particular embodiment, the Rx node 105 transmits at step 410 its consumed energy with respect to a reference consumed energy. For example, the feedback may include the energy consumed by the Rx node 105 during a certain time-window with the selected mode, in comparison to the energy consumption in non-data reception mode (IDLE-mode). In a further particular embodiment, the reference level may be a sleep state power or another well-defined energy consumption level in the Rx node 105, which is known to the Rx node 105 but not necessary to be revealed to the TX-node 110. The energy consumption report can further be reported as an aggregated value for the entire data session, or it could be reported for each transport block. A more detailed report at step 410 can enable the Tx node 110 to learn where are the most energy consuming transmission such as, for example, enabling the Tx node 110 to avoid using 64 QAM when it has high energy cost.

For determining the energy metric at step 405, in a further particular embodiment, the Rx node 105 may directly measure its current consumption during an observation period and obtain an average current or energy consumption estimate. The Rx node 105 may subtract other known power consumption contributions such as, for example, those due to screen or application processor activity.

In another particular embodiment, the Rx node 105 may use a detailed model of its power consumption (e.g., power levels at different operational states), noting its activity timeline (e.g., a sequence of operations, sleep states, and transitions) associated with a received/transmitted data sequence and accumulate the energy over the relevant states for each mode A/B.

In a particular embodiment, the reported energy consumption could also comprise a combination of an energy efficiency metric and a quality-of-service score for the RX node 105. For example, a value 0 for one mode could indicate that the QoS is not met. Alternatively, the two metrics may be provided as two separate scores.

### Machine Learning

In a particular embodiment, the more capable receiver (i.e., Rx node 105) for mode B operation can be implemented using machine learning methods such as, for example, artificial neural networks that rely on models. The models can be selected from a set of pre-trained models or can be trained using the data that is collected from the transmitter in the network. The following examples are based on whether pre-trained models are used or whether training models are triggered in the network. Any of these examples may be applied to signaling examples described above with regard to FIGS. 1-4. In various particular embodiments, the Rx node 105 may indicate if it supports training new models or selecting a model from a list of existing pre-trained models or updating the existing models, and/or the Tx node 110 may indicate if it can send the operation ID to be used by the receiver for model selection,

### Selecting a Pre-Trained Model:

According to certain embodiments, a set of models can be pre-trained in Rx node 105. Each set of models may correspond to an operation setting or a group of operation settings of Tx node 110. For example, each model can be corresponding to specific PA back-off value, carrier frequency, MCS index, and SNR value. Where Tx node 110 is the controlling node, Tx node 110 sends the operation ID(s) corresponding to the operation setting of the Tx node 110. The operation setting may correspond to the setting of transmit parameters of Tx node 110 such as, for example, PA back-off, digital-to-analog converter resolution, PA bias current. The Rx node 105 selects the pre-trained model corresponding to the operation ID.

However, where Rx node 105 is the controlling node, Rx node 105 selects one of the pre-trained models such as, for example, based on the energy consumption requirements, and sends the associated operation ID(s) to Tx node 110. Tx node 110 then sets the operation setting according to the operation identifier(s).

### Training a New Model:

In a particular embodiment, a model can be trained at the Rx node 105 for given operation setting using the training data from Tx node 110. The training data can be, for example, the known transmit bits and the corresponding real and imaginary part of the received equalized symbols, or the real and imaginary part of the received symbols, or the soft bits corresponding to the received symbols, and transmit parameters such as MCS, and parameters estimated at receiver such as the estimated SNR value, in various particular embodiments.

In a particular embodiment, Rx node 105 sends a request for training data. The request may include information such as:
the minimum information that is required for proper training, e.g. the minimum number of symbols to be transmitted,
the trade-off between the number of training samples and the expected decoding performance,
the level of energy saving at the Rx node 105, indicating the available energy for training, and, thus, the number of transmitted training samples can be adapted to this energy level.
   The Tx node 110 then sends training samples for each of the desired transmit setting (e.g. MCS), e.g. a set of modulated bits known to the Rx node 105 and Rx node 105 trains the model

### Update an Existing Model:

In a particular embodiment, a set of models can be pre-trained in the Rx node 105. Each set of models may correspond to an operation setting or a group of operation settings, and the models can be updated using training data.

Where Tx node 110 is the controlling node, Tx node 110 sends the operation ID(s) corresponding to the operation setting of the Tx node 110. The Rx node 105 then selects the pre-trained model corresponding to the operation ID. In a particular embodiment, the Rx node 105 sends a request for training data to update the model, and Tx node 110 sends training samples. In various particular embodiments, the training samples can include one or more or a mix of different MCS, for example, and a mix of QPSK, 16 QAM, 64 QAM, etc. Thereafter, Rx node 105 trains the model.

Conversely, where Rx node 105 is the controlling node, Rx node 105 selects one of the pre-trained models based on, for example, the energy consumption requirements of Rx node 105 and sends the associated operation ID(s) to the Tx node 110. Thereafter, Tx node 110 sets the operation setting according to the operation identifier(s).

In a particular embodiment, Rx node 105 may send a request for training data to update the model. Thereafter, Tx node 110 sends training samples and Rx node 105 trains the model.

Example Scenarios to which the Methods, Techniques, and Solutions can be Applied:

The methods, techniques, and solutions described above can be applied in several scenarios to provide energy efficient operation of PA without violating the regulatory requirements on out of band emission. For example, the idea can be applied in the ‘multicarrier operation’ or when the ‘same operators own adjacent carriers’. In one particular embodiment, the Rx node 105 (which may include a UE in the DL scenario) operates on carrier F2 while F1 and F3 also belong to the same operator. In another particular embodiment, the Rx node 105 that supports ML is scheduled/configured in the mid carrier(s) within the Tx node 110. In this scenario, the Tx node 110 (which may include a BS in the DL scenario) can transmit with coarse TX EVM but emissions will not hit other operators. The same approach can be applied in UL if the Tx node 110 supports a ML capable Rx node 105, and UE transmission will cause additional emissions to the same operator's carriers (F2 and F3).

In a particular embodiment, Tx node 110 adjusts the quality of modulated signal while meeting the regulatory emission requirements according to the machine learning capability of the Rx node 105 to detect signals with degraded modulation quality (e.g. higher EVM). More capable receivers (ML-based) can compensate the impact of A) nonlinearity by performing advanced receiver algorithms such as digital post processing and/or ML demapping of the received signal, and as a result, more distortion due to PA nonlinearities in the received signal can be tolerated. Less back-off can be applied when the receiver is more capable of handling distortions which leads to more energy efficient operation of the transmitter.

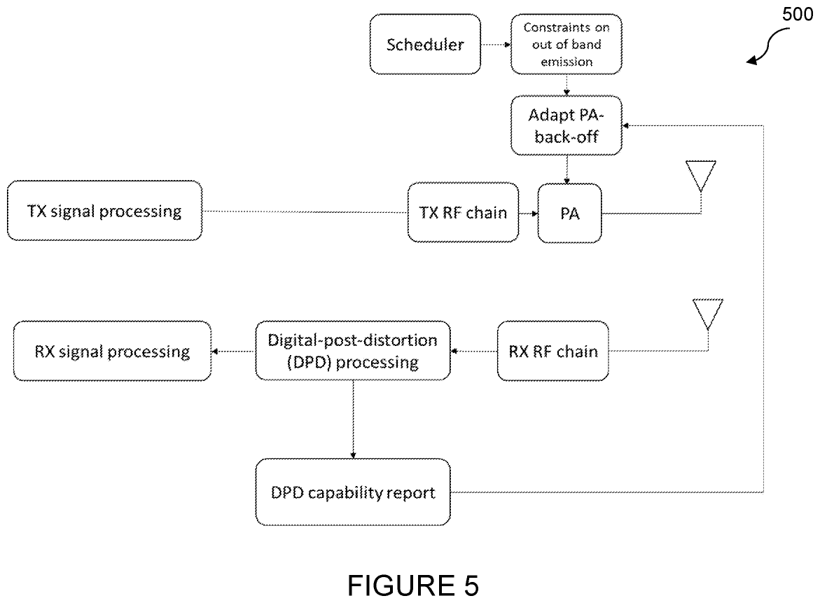

FIG. 5 illustrates a flow diagram where a Tx node 110 can adapt the PA back-off based on the feedback from the Rx node 105, according to certain embodiments. This feedback may relate to the receiver's capability to process and compensate the distortions.

The receiver capability can be, for example, the capability to perform digital post distortion at the receiver to compensate the distortions due to the transmitters's PA nonlinearities, in a particular embodiment. Additionally or alternatively, the receiver capability may include the capability to perform ML methods such as ML/AI demapper, which may include, for example, neural network demapper, for performing signal detection in the presence of distortions. The transmitter adjusts the level of distortions in the signal based on the receiver's capability by adjusting PA back-off. For example, when the receiver has the capability to process signals subject to high level of distortions, lower PA back-off can be applied and, thus, the PA operates in more nonlinear operating point.

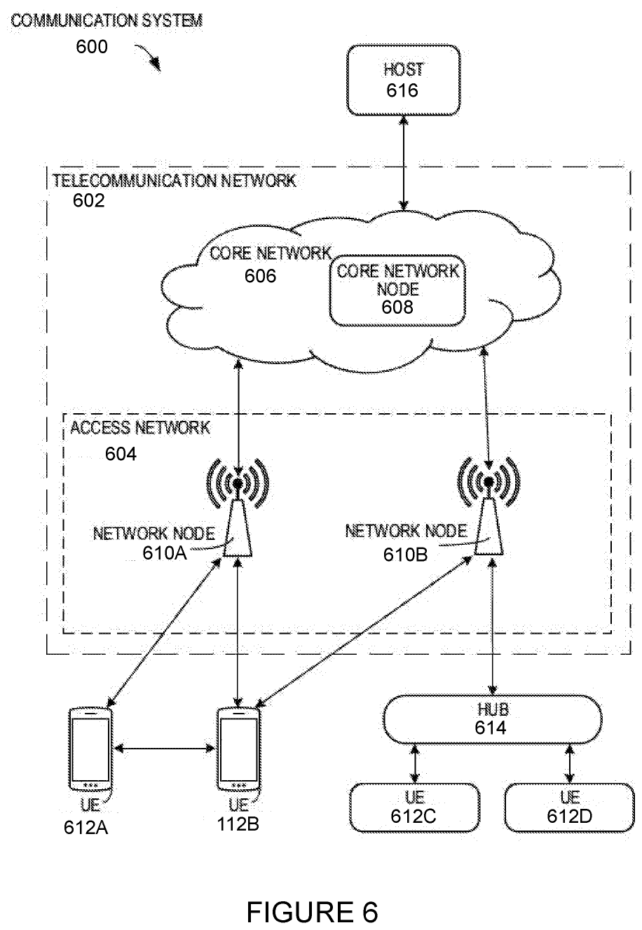

FIG. 6 shows an example of a communication system 600 in accordance with some embodiments. In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3rd Generation Partnership Project (3GPP) access node or non-3GPP access point. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

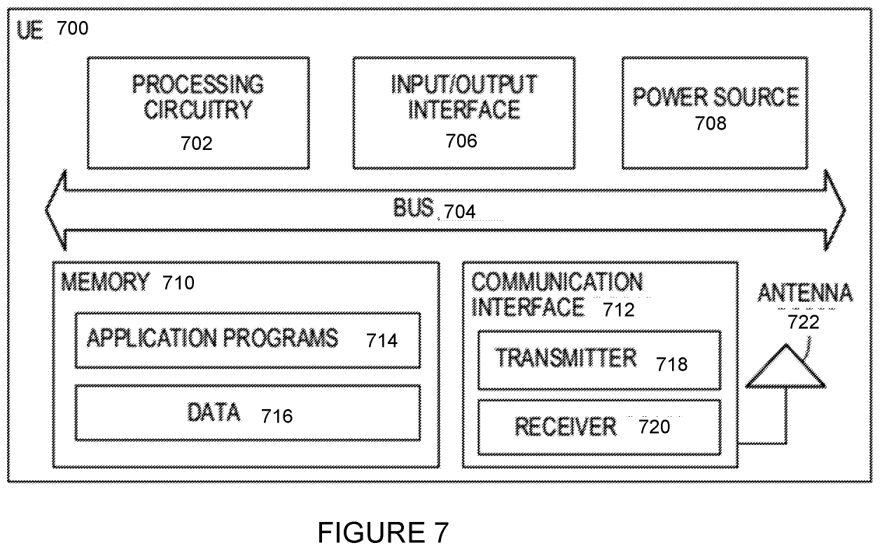

FIG. 7 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

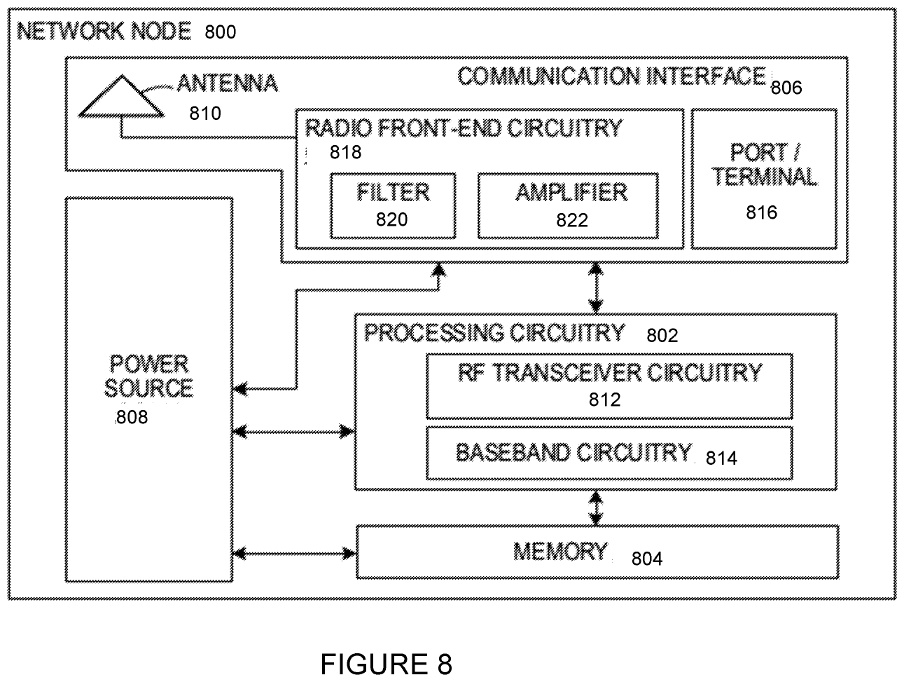

FIG. 8 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs.

In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

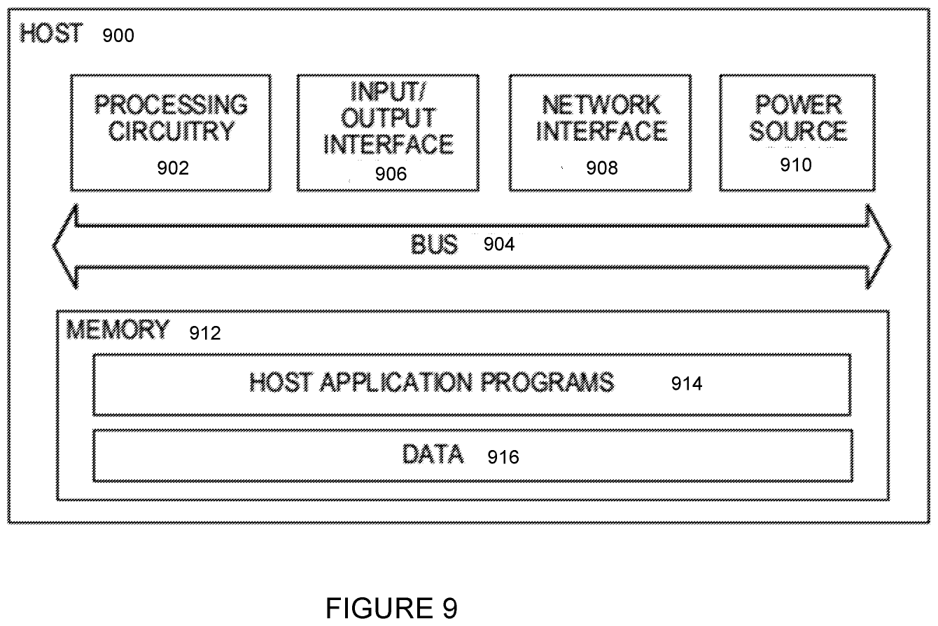

FIG. 9 is a block diagram of a host 900, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

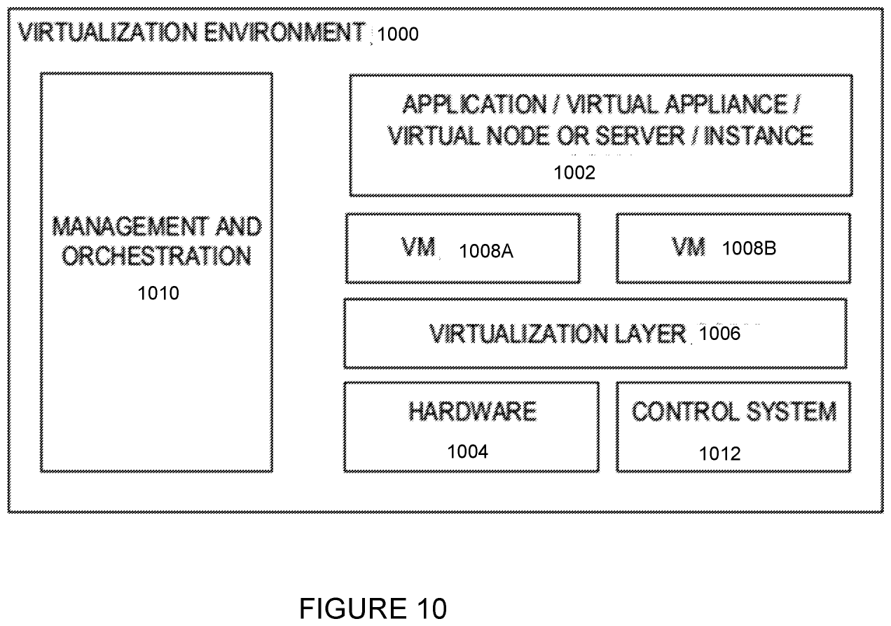

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment 1000 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006.

Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g. such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

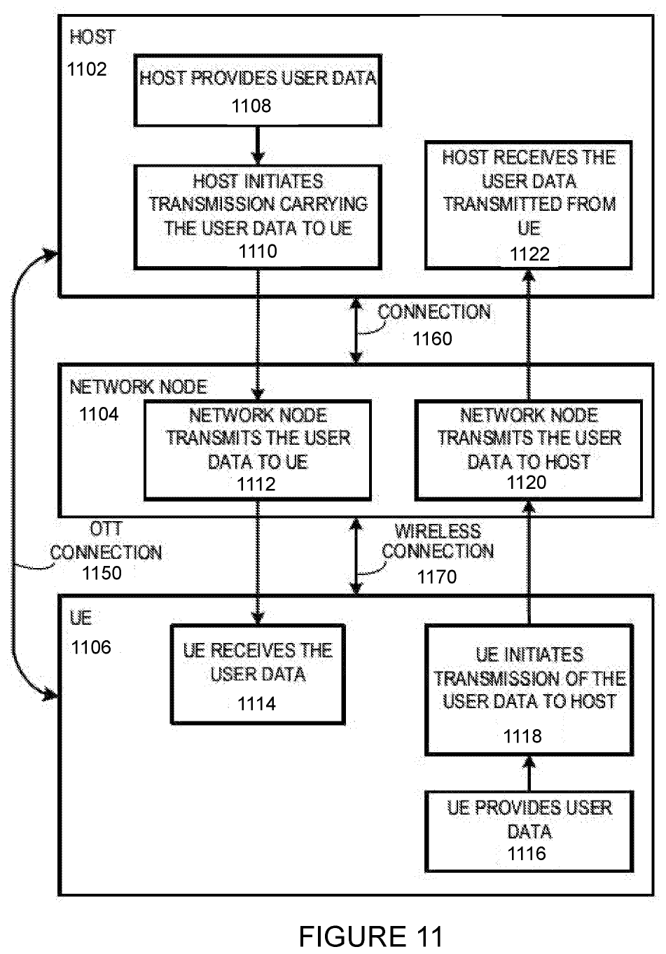

FIG. 11 shows a communication diagram of a host 1102 communicating via a network node 1104 with a UE 1106 over a partially wireless connection in accordance with some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

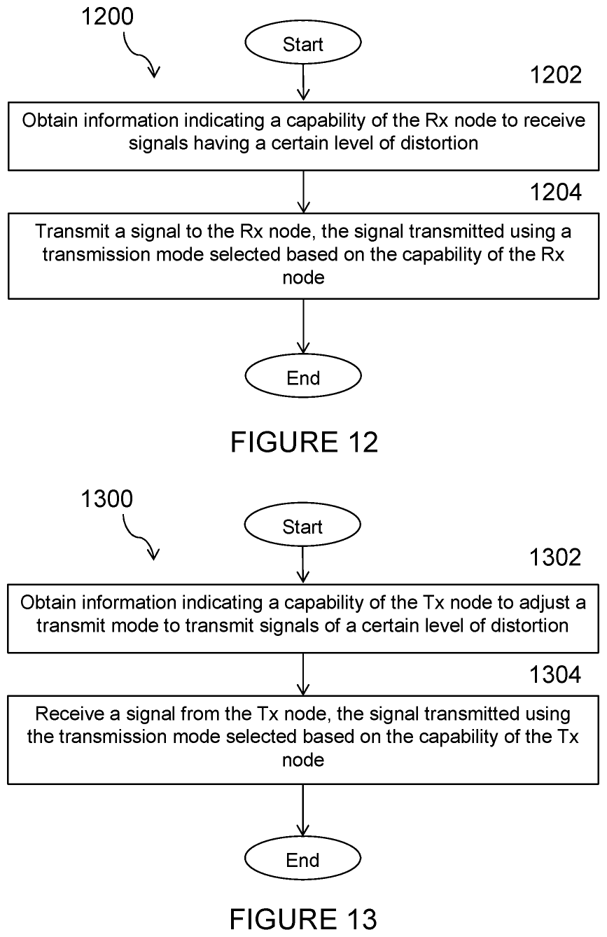

FIG. 12 illustrates a method 1200 by a Tx node 110 for adapting a signal quality based on a capability of a Rx node 105, according to certain embodiments. The method begins as step 1202 when the Tx node 110 obtains information indicating a capability of the Rx node 105 to receive signals having a certain level of distortion. The Tx node 110 transmits a signal to the Rx node 105. The signal is transmitted using a transmission mode selected based on the capability of the receiving node.

In a particular embodiment, transmitting the signal based on the capability of the Rx node 105 includes selecting the transmission mode from a plurality of modes. Each of the plurality of transmission modes is associated with a respective one of a plurality of distortion levels.

In a particular embodiment, each mode of the plurality of modes is associated with at least one transmitter setting that effects a respective level of distortion inserted into transmitted signals.

In a particular embodiment, the at least one transmitter setting comprises at least one of: an operating point of a power amplifier; a transmission power level; a maximum power reduction, MPR; a modulation and coding, MCS, scheme; and training sample or data.

In a particular embodiment, at least one of: the signal transmitted using the transmission mode selected from the plurality of modes is of a lower quality than a first previously transmitted signal that was transmitted according to a different transmission mode; the signal transmitted using the transmission mode selected from the plurality of modes is of a higher quality than a second previously transmitted signal that was transmitted according to a different transmission mode; the signal transmitted using the transmission mode selected from the plurality of modes is transmitted at a lower transmit power than a third previously transmitted signal that was transmitted according to a different transmission mode; and the signal transmitted using the transmission mode selected from the plurality of modes is transmitted at a higher transmit power than a fourth previously transmitted signal that was transmitted according to a different transmission mode.

In a particular embodiment, the capability of the Rx node 105 to receive signals associated with the certain level of distortion comprises a capability of the Rx node to receive signals of a modulation quality equal to or above a minimum modulation quality, and the transmission mode of the signal is selected based on the minimum modulation quality.

In a particular embodiment, the Tx node 110 stores transmission mode information for the plurality of transmission modes. The transmission mode information includes a first transmission mode, a second transmission mode, and a first modulation quality threshold. The Tx node 110 compares the minimum modulation quality of the receiving node to the first modulation quality, selects the first transmission mode if a minimum modulation quality of the receiving node is greater than the first modulation quality threshold, or selects the second transmission mode if the minimum modulation quality of the receiving node is less than the first modulation quality threshold.

In a particular embodiment, a modulation quality requirement of the second transmission mode is less than a modulation quality requirement of the first transmission mode.

In a particular embodiment, the Tx node 110 stores mode transmission information for each of the plurality of transmission modes, and the transmission mode information comprises a first modulation quality threshold associated with a first mode and a second modulation quality threshold associated with a second transmission mode. Based on the information indicating the capability of the Rx node 105, the Tx node 110 comparing the minimum modulation quality of the Rx node 105 to at least one of the first modulation quality threshold and the second modulation quality threshold. The Tx node 110 selects the first transmission mode or the second transmission mode based on the step of comparing the minimum modulation quality of the Rx node 105 to the at least one of the first modulation quality threshold and the second modulation quality threshold.

In a particular embodiment, obtaining the information indicating a capability of the receiving node comprises at least one of: receiving at least a portion of the information from the receiving node, receiving at least a portion of the information from a node other than the Rx node 105, determining the capability of the Rx node 105 based on a number of retransmissions of a previously transmitted signal sent to the Rx node 105, and determining the capability of the Rx node 105 node based on a feedback signal received from the Rx node 105.

In a particular embodiment, the certain level of distortion comprises at least one of: a value of allowable error-vector-magnitude, EVM; a value of allowable Adjacent Channel Leakage Ratio, ACLR; a value of allowable Intermodulation Distortion, IMD; and a value of allowable frequency error.

In a particular embodiment, the Tx node 110 comprises a user equipment or other wireless device, the Rx node 105 comprises a network node, and the signal is transmitted on an uplink from the user equipment or other wireless device to the network node.

In a particular embodiment, the Tx node 110 comprises a network node; the Rx node 105 comprises a user equipment or other wireless device; and the signal is transmitted on a downlink from the network node to the user equipment or other wireless device.

In a particular embodiment, the Tx node 110 comprises a first user equipment or first wireless device, and the Rx node 105 comprises a second user equipment or second wireless device.

FIG. 13 illustrates a method 1300 by a Rx node 105 for adapting a reception mode based on a capability of a Tx node 110, according to certain embodiments. At step 1302, the Rx node 105 obtains information indicating the capability of the TX node 110 to adjust a transmit mode to transmit signals having a certain level of distortion. At step 1304, the Rx node 105 receives a signal from the Tx node 110. The signal is transmitted using a transmission mode selected based on the capability of the Tx node 110.

In a particular embodiment, based on the capability of the Tx node 110 to adjust the transmit mode to transmit signals having the certain level of distortion, the Rx node 105 selects a reception mode from a plurality of reception modes. Each of the plurality of reception modes is associated with a respective one of a plurality of distortion levels. The Rx node 105 transmits, to the Tx node 110, an indication of the reception mode that is selected from the plurality of reception modes. The signal from the Tx node 110 is received based on the reception mode that is selected.

In a particular embodiment, the reception mode that is selected by the Rx node 105 corresponds to the transmission mode used to transmit the signal by the Tx node 110, and the transmission mode is associated with at least one transmitter setting that effects the certain level of distortion inserted into the transmitted signal.

In a particular embodiment, the at least one transmitter setting comprises at least one of: an operating point of a power amplifier; a transmission power level; a maximum power reduction, PR; a modulation and coding, MCS, scheme; and training sample or data.

In a particular embodiment, at least one of: the signal received from the Tx node 110 is of a lower quality than a first previously received signal that was received according to a reception mode that is different from the reception mode selected from the plurality of reception modes; the signal received using the reception mode selected from the plurality of reception modes is of a higher quality than a second previously received signal that was transmitted according to a reception mode that is different from the reception mode selected from the plurality of reception modes; the signal received using the reception mode selected from the plurality of reception modes is received at a lower transmit power than a third previously received signal that was transmitted according to a reception mode that is different from the mode selected from the plurality of reception modes; and the signal received using the reception mode selected from the plurality of reception modes is received at a higher transmit power than a fourth previously received signal that was transmitted according to a reception mode that is different from the reception mode selected from the plurality of reception modes.

In a particular embodiment, the information indicating the capability of the Tx node 110 to adjust the level of distortion in the transmitted signals comprises a capability of the Tx node 110 to send the transmitted signals of a modulation quality that is equal to or above a minimum modulation quality, and the reception mode of the signal is selected based on the minimum modulation quality.

In a particular embodiment, the Rx node 105 stores reception mode information for the plurality of reception modes, and the reception mode information comprises a first reception mode, a second reception mode, and a first modulation quality threshold. The Rx node 105 compares the minimum modulation quality of the transmission mode to the first modulation quality threshold, selects the first reception mode if the minimum modulation quality of the transmitting node is greater than the first modulation quality threshold, and selects the second reception mode if the minimum modulation quality of the transmitting node is less than the first modulation quality threshold.

In a particular embodiment, a modulation quality requirement of the second reception mode is less than a modulation quality requirement of the first reception mode.

In a particular embodiment, the Rx node 105 stores reception mode information for each of the plurality of reception modes. The reception mode information comprises a first modulation quality threshold associated with a first reception mode and a second modulation quality threshold associated with a second reception mode. The Rx node 105 compares a minimum modulation quality of the transmitting node to at least one of the first modulation quality threshold and the second modulation quality threshold. The Rx node 105 selects the first reception mode or the second reception mode based on the step of comparing the minimum modulation quality of the transmitting node to the at least one of the first modulation quality threshold and the second modulation quality threshold.

In a particular embodiment, obtaining the information indicating the capability of the Tx node 110 comprises at least one of: receiving at least a portion of the information from the Tx node 110 receiving at least a portion of the information from a node other than the Tx node 110, determining the capability of the Tx node 110 based on a number of retransmissions of a previously transmitted signal sent to the Tx node 110, and determining the capability of the Tx node 110 based on a feedback signal received from the Tx node 110.

In a particular embodiment, the level of distortion comprises at least one of: a value of allowable error-vector-magnitude, EVM; a value of allowable Adjacent Channel Leakage Ratio, ACLR; a value of allowable Intermodulation Distortion, IMD; and a value of allowable frequency error.

In a particular embodiment, the Rx node 105 comprises a user equipment or other wireless device; the Tx node 110 comprises a network node; and the signal is received on a downlink from the network node to the user equipment or other wireless device.

In a particular embodiment, the Rx node 105 comprises a network node; the Tx node 110 comprises a user equipment or other wireless device; and the signal is received on an uplink from the user equipment or other wireless device to the network node.

In a particular embodiment, the Rx node 105 comprises a first user equipment or first wireless device, and the Tx node 110 comprises a second user equipment or second wireless device.

In a particular embodiment, receiving the signal comprises receiving the signal by performing advanced receiver algorithms.

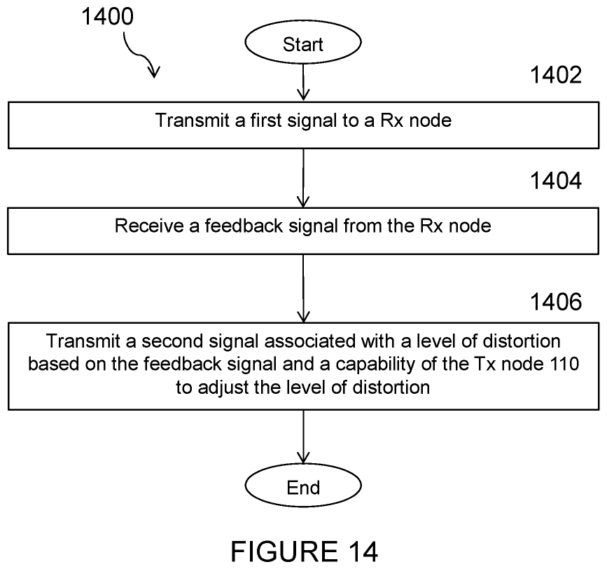

FIG. 14 illustrates a method 1400 by a Tx node 110 for transmitting a signal quality based on a capability of the Tx node 110, according to certain embodiments. The method includes transmitting a first signal to a Rx node 105, at step 1402. At step 1404, the Tx node 110 receives a feedback signal from a Rx node 105. At step 1406, the Tx node 110 transmits a second signal associated with a level of distortion based on the feedback signal and a capability of the Tx node 110 to adjust the level of distortion.

In a particular embodiment, the Tx node 110 transmits, to the Rx node 105, information indicating the capability of the Tx node 110 to adjust a level of distortion in transmitted signals. In a particular embodiment, the capability of the Tx node 110 is at least partially determined based on the feedback signal from the Rx node 105.

In a particular embodiment, the first signal comprises data intended for the Rx node 105. In a particular embodiment, the first signal is broadcast to the Rx node 105 and at least one other Rx node.

In a particular embodiment, the feedback signal comprises at least one of: an indication that the Rx node 105 received the first signal; an indication that the Rx node 105 did not receive the first signal; a channel quality indicator; and at least one value associated with a channel quality measurement.

In a particular embodiment, the Tx node 110 selects a mode from a plurality of modes for transmitting the second signal, and each of the plurality of modes is associated with a respective one of a plurality of allowed distortion levels.

In a particular embodiment, each mode of the plurality of modes is associated with a at least one transmitter setting that effects the level of distortion inserted into transmitted signals.

In a particular embodiment, the at least one transmitter setting comprises an operating point of a power amplifier.

In a particular embodiment, at least one of: the second signal transmitted using the mode selected from the plurality of modes is of a lower quality than a first previously transmitted signal that was transmitted according to a different mode, the second signal transmitted using the mode selected from the plurality of modes is of a higher quality than a second previously transmitted signal that was transmitted according to a different mode, the second signal transmitted using the mode selected from the plurality of modes is transmitted at a lower transmit power than a third previously transmitted signal that was transmitted according to a different mode, and the second signal transmitted using the mode selected from the plurality of modes is transmitted at a higher transmit power than a fourth previously transmitted signal that was transmitted according to a different mode.

In a particular embodiment, the information indicating the capability of the Tx node 110 to adjust a level of distortion in transmitted signals comprises a capability of the Tx node 110 to adjust a modulation quality equal to or above a minimum modulation quality, and the mode of the second signal is selected based on the minimum modulation quality.

In a particular embodiment, the Tx node 110 stores mode information for the plurality of modes, the mode information comprising a first mode, a second mode, and a first modulation quality threshold. The Tx node 110 compares the minimum modulation quality of the Tx node 110 to the first modulation quality. The Tx node 110 then selects the first mode if a minimum modulation quality of the transmitting node is greater than the first modulation quality threshold or selects the second mode if the minimum modulation quality of the transmitting node is less than the first modulation quality threshold.

In a particular embodiment, a modulation quality requirement of the second mode is less than a modulation quality requirement of the first mode.

In a particular embodiment, the Tx node 110 stores mode information for each of the plurality of modes, and the mode information comprises a first modulation quality threshold associated with a first mode and a second modulation quality threshold associated with a second mode. Based on the information indicating the capability of the Tx node 110, the Tx node 110 compares the minimum modulation quality of the Tx node 110 to at least one of the first modulation quality threshold and the second modulation quality threshold. The Tx node 110 then selects the first mode or the second mode based on the step of comparing the minimum modulation quality of the transmitting node to the at least one of the first modulation quality threshold and the second modulation quality threshold.

In a particular embodiment, the level of distortion comprises at least one of: a value of allowable EVM; a value of allowable ACLR; and a value of allowable IMD.

In a particular embodiment, the Tx node 110 comprises a user equipment or other wireless device, and the Rx node 105 comprises a network node.

In a particular embodiment, the Tx node 110 comprises a network node; and the Rx node 105 comprises a user equipment or other wireless device.

In a particular embodiment, Tx node 110 comprises a first user equipment or first wireless device, and the Rx node 105 comprises a second user equipment or second wireless device.

### Example Embodiments

### Group A Example Embodiments

Example Embodiment A1. A method by a transmitting node for adapting a transmit signal quality based on a capability of a receiving node, the method comprising: any of the steps, features, or functions described above, either alone or in combination with other steps, features, or functions described above.

Example Embodiment A2. The method of the previous embodiment, further comprising one or more additional steps, features or functions described above.

Example Embodiment A3. The method of any of the previous embodiments, wherein the transmitting node comprises a user equipment.

Example Embodiment A4. The method of any of the previous embodiments, wherein the transmitting node comprises a network node.

Example Embodiment A5. The method of any of the previous embodiments, further comprising: providing user data; and forwarding the user data to a host computer via the transmission to the network node.

### Group B Example Embodiments

Example Embodiment B1. A method performed by a receiving node for receiving a transmit signal quality based on a capability of the receiving node, the method comprising: any of the steps, features, or functions described above, either alone or in combination with other steps, features, or functions described above.

Example Embodiment B2. The method of the previous embodiment, further comprising one or more additional steps, features or functions described above.

Example Embodiment B3. The method of any of the previous embodiments, wherein the receiving node comprises a user equipment.

Example Embodiment B4. The method of any of the previous embodiments, wherein the receiving node comprises a network node.

Example Embodiment B5. The method of any of the previous embodiments, further comprising: obtaining user data; and forwarding the user data to a host or a user equipment.

### Group C Example Embodiments

Example Embodiment C1. A method by a transmitting node for adapting a transmit signal quality based on a capability of a receiving node, the method comprising: obtaining information indicating a capability of the receiving node; and based on the capability of the receiving node, transmitting the signal using a mode selected from a plurality of modes.

Example Embodiment C2. The method of Example Embodiment C1, wherein the information indicating the capability of the receiving node comprises an ability of the receiving node to receive transmit signals of a modulation quality.

Example Embodiment C3. The method of Example Embodiment C2, wherein the modulation quality comprises a minimum modulation quality, and the receiving node is able to receive transmit signals equal to or above the minimum modulation quality.

Example Embodiment C4. The method of any one of Example Embodiments C1 to C3, further comprising storing mode information for the plurality of modes, wherein the plurality of modes is associated with at least one modulation quality threshold.

Example Embodiment C5. The method of Example Embodiment C4, wherein: the mode information comprises a first mode, a second mode, and a first modulation quality threshold, and the method further comprises: based on the information indicating the capability of the receiving node, comparing a minimum modulation quality of the receiving node to the first modulation quality; selecting the first mode if a minimum modulation quality of the receiving node is greater than the first modulation quality threshold, or selecting the second mode if the minimum modulation quality of the receiving node is less than the first modulation quality threshold, wherein at least one requirement of the second mode is less stringent than at least one requirement of the first mode.

Example Embodiment C6. The method of Example Embodiment C5, wherein a modulation quality requirement of the second mode is less than a modulation quality requirement of the first mode.

Example Embodiment C7. The method of any one of Example Embodiments C1 to C6, further comprising storing mode information indicating the plurality of transmit modes, wherein each of the plurality of transmit modes is associated with at least one modulation quality threshold.

Example Embodiment C8. The method of Example Embodiment C7, wherein the mode information comprises: a first modulation quality threshold associated with a first mode; and a second modulation quality threshold associated with a transmit mode.

Example Embodiment C9. The method of Example Embodiment C4, further comprising: based on the information indicating the capability of the receiving node, comparing a minimum modulation quality of the receiving node to the first modulation quality threshold and the second modulation quality threshold; and selecting the first mode or the second mode based on the comparison.

Example Embodiment C10. The method of any one of Example Embodiments C1 to C9, wherein obtaining the information indicating a capability of the receiving node comprises receiving the information from the receiving node.

Example Embodiment C11. The method of any one of Example Embodiments C1 to C10, wherein obtaining the information indicating the capability of the receiving node comprises receiving the information from a node other than the receiving node.

Example Embodiment C12. The method of any one of Example Embodiments C1 to C11, wherein obtaining the information indicating the capability of the receiving node comprises determining the capability of the receiving node based on a number of retransmissions of a signal to the receiving node.

Example Embodiment C13. The method of any one of Example Embodiments C1 to C12, wherein obtaining the information indicating the capability of the receiving node comprises determining the capability of the receiving node based on a feedback signal received from the receiving node.

Example Embodiment C14. The method of any one of Example Embodiments C1 to C13, further comprising selecting the mode from the plurality of modes based on the information indicating the capability of the receiver.

Example Embodiment C15. The method of any one of Example Embodiments C1 to C14, wherein the signal transmitted using the mode selected from the plurality of modes is of a lower quality than a previously transmitted signal that was transmitted according to a different mode.

Example Embodiment C16. The method of any one of Example Embodiments C1 to C14, wherein the signal transmitted using the mode selected from the plurality of modes is of a higher quality than a previously transmitted signal that was transmitted according to a different mode.

Example Embodiment C17. The method of any one of Example Embodiments C1 to C14, wherein the signal transmitted using the mode selected from the plurality of modes is transmitted at a lower transmit power than a previously transmitted signal that was transmitted according to a different mode.

Example Embodiment C18. The method of any one of Example Embodiments C to C14, wherein the signal transmitted using the mode selected from the plurality of modes is transmitted at a higher transmit power than a previously transmitted signal that was transmitted according to a different mode.

Example Embodiment C19. The method of any one of Example Embodiments C1 to C19, wherein each of the plurality of modes is associated with a respective one of a plurality of transmit power ranges.

Example Embodiment C20. The method of any one of Example Embodiments C1 to C19, wherein each of the plurality of modes is associated with a respective one of a plurality of transmit power values.

Example Embodiment C21. The method of any one of Example Embodiments C to C20, wherein: the transmitting node comprises a user equipment or other wireless device; the receiving node comprises a network node; and the signal is transmitted on an uplink from the user equipment or other wireless device to the network node.

Example Embodiment C22. The method of any one of Example Embodiments C1 to C20, wherein: the transmitting node comprises a network node; the receiving node comprises a user equipment or other wireless device; and the signal is transmitted on a downlink from the network node to the user equipment or other wireless device.

Example Embodiment C23. The method of Example Embodiments C1 to C22, further comprising: providing user data; and forwarding the user data to a host via the transmission to the network node.

Example Embodiment C24. A transmit node comprising processing circuitry configured to perform any of the methods of Example Embodiments C1 to C23.

Example Embodiment C25. A transmit node adapted to perform any of the methods of Example Embodiments C1 to C23.

Example Embodiment C26. A computer program comprising instructions which when executed on a computer perform any of the methods of Example Embodiments C1 to C23.

Example Embodiment C27. A computer program product comprising computer program, the computer program comprising instructions which when executed on a computer perform any of the methods of Example Embodiments C1 to C23.

Example Embodiment C28. A non-transitory computer readable medium storing instructions which when executed by a computer perform any of the methods of Example Embodiments C1 to C23.

### Group D Example Embodiments

Example Embodiment D1. A method by a receiving node for receiving a transmit signal quality based on a capability of the receiving node, the method comprising: transmitting information indicating a capability of the receiving node to a transmitting node or another network node; and receiving a signal from the transmitting node, the signal transmitted by the transmitting node using a mode selected from a plurality of modes based on the information indicating the capability of the receiving node.

Example Embodiment D2. The method of Example Embodiment D1, wherein the information indicating the capability of the receiving node comprises an ability of the receiving node to receive transmit signals of a modulation quality.

Example Embodiment D3. The method of Example Embodiment D2, wherein the modulation quality comprises a minimum modulation quality, and the information indicates that the receiving node is able to receive transmit signals equal to or above the minimum modulation quality.

Example Embodiment D4. The method of any one of Example Embodiments D1 to D3, wherein the plurality of modes is associated with at least one modulation quality threshold.

Example Embodiment D5. The method of Example Embodiment D4, wherein: the plurality of modes comprises a first mode and a second mode, the first and second mode are associated with a first modulation quality threshold, the signal received from the transmitting node is associated with the first mode if a minimum modulation quality of the receiving node is greater than the first modulation quality threshold or the signal received from the transmitting node is associated with the second mode if the minimum modulation quality of the receiving node is less than the first modulation quality threshold, and at least one requirement of the second mode is less stringent than at least one requirement of the first mode.

Example Embodiment D6. The method of Example Embodiment D5, wherein a modulation quality requirement of the second mode is less than a modulation quality requirement of the first mode.

Example Embodiment D7. The method of any one of Example Embodiments D1 to D6, wherein each of the plurality of transmit modes is associated with at least one modulation quality threshold.

Example Embodiment D8. The method of Example Embodiment D7, wherein: a first modulation quality threshold associated with a first mode; and a second modulation quality threshold associated with a transmit mode.

Example Embodiment D9. The method of any one of Example Embodiments D1 to D8, wherein the information indicating the capability of the receiving node is transmitted to the transmitting node.

Example Embodiment D10. The method of any one of Example Embodiments D1 to D8, wherein the information indicating the capability of the receiving node is transmitted to a network node other than the transmitting node.

Example Embodiment D11. The method of any one of Example Embodiments D1 to C10, wherein transmitting the information indicating the capability of the receiving node comprises transmitting a feedback signal to the transmitting node, and wherein the capability of the receiving node is implicitly indicated by the feedback signal.

Example Embodiment D12. The method of any one of Example Embodiments D1 to D11, wherein the signal associated with the mode selected from the plurality of modes is of a lower quality than a previously received signal that was transmitted and/or received according to a different mode.

Example Embodiment D13. The method of any one of Example Embodiments D1 to D11, wherein the signal associated with the mode selected from the plurality of modes is of a higher quality than a previously received signal that was transmitted and/or received according to a different mode.

Example Embodiment D14. The method of any one of Example Embodiments D1 to D13, wherein the signal associated with the mode selected from the plurality of modes is received at a lower transmit power than a previous signal that was transmitted and/or received according to a different mode.

Example Embodiment D15. The method of any one of Example Embodiments D1 to D13, wherein the signal associated with the mode selected from the plurality of modes is received at a higher transmit power than a previous signal that was transmitted and/or received according to a different mode.

Example Embodiment D16. The method of any one of Example Embodiments D1 to D15, wherein each of the plurality of modes is associated with a respective one of a plurality of transmit power ranges.

Example Embodiment D17. The method of any one of Example Embodiments D1 to D15, wherein each of the plurality of modes is associated with a respective one of a plurality of transmit power values.

Example Embodiment D18. The method of any one of Example Embodiments D1 to D17, wherein: the receiving node comprises a user equipment or other wireless device; the transmitting node comprises a network node; and the signal is received on a downlink.

Example Embodiment D19. The method of any one of Example Embodiments D1 to D17, wherein: the receiving node comprises a network node; the transmitting node comprises a user equipment or other wireless device; and the signal is received on an uplink.

Example Embodiment D20. The method of Example Embodiments D1 to D19, further comprising: providing user data; and forwarding the user data to a host via the transmission to the network node.

Example Embodiment D21. A receiving node comprising processing circuitry configured to perform any of the methods of Example Embodiments D1 to D20.

Example Embodiment D22. A receiving node adapted to perform any of the methods of Example Embodiments D1 to D20.

Example Embodiment D23. A computer program comprising instructions which when executed on a computer perform any of the methods of Example Embodiments D1 to D20.

Example Embodiment D24. A computer program product comprising computer program, the computer program comprising instructions which when executed on a computer perform any of the methods of Example Embodiments D1 to D20.

Example Embodiment D25. A non-transitory computer readable medium storing instructions which when executed by a computer perform any of the methods of Example Embodiments D1 to D20.

### Group E Example Embodiments

Example Embodiment E1. A method by a transmitting node for transmitting a signal quality based on a capability of a transmitting node, the method comprising: transmitting a first signal to a receiving node; receiving a feedback signal from a receiving node; and transmitting a second signal associated with a level of distortion based on the feedback signal and a capability of the transmitting node to adjust the level of distortion.

Example Embodiment E2. The method of Example Embodiment E1, further comprising: transmitting, to the receiving node, information indicating the capability of the transmitting node to adjust a level of distortion in transmitted signals.

Example Embodiment E3. The method of Example Embodiment E2, wherein the capability of the transmitting node is at least partially determined based on the feedback signal from the receiving node.

Example Embodiment E4. The method of any one of Example Embodiments E1 to E3, wherein the first signal comprises data intended for the receiving node.

Example Embodiment E5. The method of any one of Example Embodiments E1 to E4, wherein the first signal is broadcast to the receiving node and at least one other receiving node.

Example Embodiment E6. The method of any one of Example Embodiments E1 to E5, wherein the feedback signal comprises at least one of: an indication that the receiving node received the first signal; an indication that the receiving node did not receive the first signal; a channel quality indicator; and at least one value associated with a channel quality measurement.

Example Embodiment E7. The method of any one of Example Embodiments E1 to E6, further comprising: selecting a mode from a plurality of modes for transmitting the second signal, and wherein each of the plurality of modes is associated with a respective one of a plurality of allowed distortion levels.

Example Embodiment E8. The method of Example Embodiment E7, wherein each mode of the plurality of modes is associated with a at least one transmitter setting that effects the level of distortion inserted into transmitted signals.

Example Embodiment E9. The method of Example Embodiment E8, wherein the at least one transmitter setting comprises an operating point of a power amplifier.

Example Embodiment E10. The method of any one of Example Embodiments E7 to E9, wherein at least one of: the second signal transmitted using the mode selected from the plurality of modes is of a lower quality than a first previously transmitted signal that was transmitted according to a different mode, the second signal transmitted using the mode selected from the plurality of modes is of a higher quality than a second previously transmitted signal that was transmitted according to a different mode, the second signal transmitted using the mode selected from the plurality of modes is transmitted at a lower transmit power than a third previously transmitted signal that was transmitted according to a different mode, and the second signal transmitted using the mode selected from the plurality of modes is transmitted at a higher transmit power than a fourth previously transmitted signal that was transmitted according to a different mode.

Example Embodiment E11. The method of any one of Example Embodiments E2 to E10, wherein: the information indicating the capability of the transmitting node to adjust a level of distortion in transmitted signals comprises a capability of the transmitting node to adjust a modulation quality equal to or above a minimum modulation quality, and the mode of the second signal is selected based on the minimum modulation quality.

Example Embodiment E12. The method of Example Embodiment E11, further comprising: storing mode information for the plurality of modes, the mode information comprising a first mode, a second mode, and a first modulation quality threshold; comparing the minimum modulation quality of the transmitting node to the first modulation quality; selecting the first mode if a minimum modulation quality of the transmitting node is greater than the first modulation quality threshold, or selecting the second mode if the minimum modulation quality of the transmitting node is less than the first modulation quality threshold.

Example Embodiment E13. The method of Example Embodiment E12, wherein a modulation quality requirement of the second mode is less than a modulation quality requirement of the first mode.

Example Embodiment E14. The method of Example Embodiment E11, further comprising: storing mode information for each of the plurality of modes, wherein the mode information comprises a first modulation quality threshold associated with a first mode and a second modulation quality threshold associated with a second mode; based on the information indicating the capability of the transmitting node, comparing the minimum modulation quality of the transmitting node to at least one of the first modulation quality threshold and the second modulation quality threshold; and selecting the first mode or the second mode based on the step of comparing the minimum modulation quality of the transmitting node to the at least one of the first modulation quality threshold and the second modulation quality threshold.

Example Embodiment E15. The method of any one of Example Embodiments E1 to E14, wherein the level of distortion comprises at least one of: a value of allowable error-vector-magnitude, EVM; a value of allowable Adjacent Channel Leakage Ratio, ACLR; and a value of allowable Intermodulation Distortion, IMD.

Example Embodiment E16. The method of any one of Example Embodiments E1 to E15, wherein: the transmitting node comprises a user equipment or other wireless device; the receiving node comprises a network node.

Example Embodiment E17. The method of any one of Example Embodiments E1 to E15, wherein: the transmitting node comprises a network node; the receiving node comprises a user equipment or other wireless device.

Example Embodiment E18. The method of any one of Example Embodiments E1 to E15, wherein: the transmitting node comprises a first user equipment or first wireless device; and the receiving node comprises a second user equipment or second wireless device.

### Group F Example Embodiments

Example Embodiment F1. A user equipment comprising: processing circuitry configured to perform any of the steps of any of the Group A, B, C, D, and E Example Embodiments; and power supply circuitry configured to supply power to the processing circuitry.

Example Embodiment F2. A network node comprising: processing circuitry configured to perform any of the steps of any of the Group A, B, C, D, and E Example Embodiments; power supply circuitry configured to supply power to the processing circuitry.

Example Embodiment F3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A, B, C, D, and E Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment F4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A, B, C, D, and E Example Embodiments to receive the user data from the host.

Example Embodiment F5. The host of the previous Example Embodiment, wherein the cellular network further includes a network node configured to communicate with the UE to transmit the user data to the UE from the host.

Example Embodiment F6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment F8. The method of the previous Example Embodiment, further comprising: at the host, executing a host application associated with a client application executing on the UE to receive the user data from the UE.

Example Embodiment F9. The method of the previous Example Embodiment, further comprising: at the host, transmitting input data to the client application executing on the UE, the input data being provided by executing the host application, wherein the user data is provided by the client application in response to the input data from the host application.

Example Embodiment F10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A, B, C, D, and E Example Embodiments to transmit the user data to the host.

Example Embodiment F11. The host of the previous Example Embodiment, wherein the cellular network further includes a network node configured to communicate with the UE to transmit the user data from the UE to the host.

Example Embodiment F12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F13. A method implemented by a host configured to operate in a communication system that further includes a network node and a user equipment (UE), the method comprising: at the host, receiving user data transmitted to the host via the network node by the UE, wherein the UE performs any of the steps of any of the Group A, B, C, D, and E Example Embodiments to transmit the user data to the host.

Example Embodiment F14. The method of the previous Example Embodiment, further comprising: at the host, executing a host application associated with a client application executing on the UE to receive the user data from the UE.

Example Embodiment F15. The method of the previous Example Embodiment, further comprising: at the host, transmitting input data to the client application executing on the UE, the input data being provided by executing the host application, wherein the user data is provided by the client application in response to the input data from the host application.

Example Embodiment F16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group A, B, C, D, and E Example Embodiments to transmit the user data from the host to the UE.

Example Embodiment F17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment F18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group A, B, C, D, and E Example Embodiments to transmit the user data from the host to the UE.

Example Embodiment F19. The method of the previous Example Embodiment, further comprising, at the network node, transmitting the user data provided by the host for the UE.

Example Embodiment F20. The method of any of the previous 2 Example Embodiments, wherein the user data is provided at the host by executing a host application that interacts with a client application executing on the UE, the client application being associated with the host application.

Example Embodiment F21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group A, B, C, D, and E Example Embodiments to transmit the user data from the host to the UE.

Example Embodiment F22. The communication system of the previous Example Embodiment, further comprising: the network node; and/or the user equipment.

Example Embodiment F23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group A, B, C, D, and E Example Embodiments to receive the user data from a user equipment (UE) for the host.

Example Embodiment F24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F25. The host of the any of the previous 2 Example Embodiments, wherein the initiating receipt of the user data comprises requesting the user data.

Example Embodiment F26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group A, B, C, D, and E Example Embodiments to receive the user data from the UE for the host.

Example Embodiment F27. The method of the previous Example Embodiment, further comprising at the network node, transmitting the received user data to the host.

1. A method by a transmitting node for adapting a transmission mode based on a capability of a receiving node, the method comprising:
obtaining information indicating a capability of the receiving node to receive signals having a certain level of distortion; and
transmitting a signal to the receiving node, the signal transmitted using a transmission mode selected based on the capability of the receiving node.

2. The method of claim 1, wherein transmitting the signal based on the capability of the receiving node comprises:
selecting the transmission mode from a plurality of modes, wherein each of the plurality of transmission modes is associated with a respective one of a plurality of distortion levels.

3. The method of claim 2, wherein each mode of the plurality of modes is associated with a at least one transmitter setting that effects a respective level of distortion inserted into transmitted signals.

4. The method of claim 3, wherein the at least one transmitter setting comprises at least one of:
an operating point of a power amplifier;
a transmission power level;
a maximum power reduction (MPR);
a modulation and coding (MCS) scheme; and
training sample or data.

5. The method of claim 2, wherein at least one of:
the signal transmitted using the transmission mode selected from the plurality of modes is of a lower quality than a first previously transmitted signal that was transmitted according to a different transmission mode,
the signal transmitted using the transmission mode selected from the plurality of modes is of a higher quality than a second previously transmitted signal that was transmitted according to a different transmission mode,
the signal transmitted using the transmission mode selected from the plurality of modes is transmitted at a lower transmit power than a third previously transmitted signal that was transmitted according to a different transmission mode, and
the signal transmitted using the transmission mode selected from the plurality of modes is transmitted at a higher transmit power than a fourth previously transmitted signal that was transmitted according to a different transmission mode.

6. The method of claim 2, wherein:
the capability of the receiving node to receive signals associated with the certain level of distortion comprises a capability of the receiving node to receive signals of a modulation quality equal to or above a minimum modulation quality, and
the transmission mode of the signal is selected based on the minimum modulation quality.

7. The method of claim 6, further comprising:
storing transmission mode information for the plurality of transmission modes, the transmission mode information comprising a first transmission mode, a second transmission mode, and a first modulation quality threshold;
comparing the minimum modulation quality of the receiving node to the first modulation quality;
selecting the first transmission mode if a minimum modulation quality of the receiving node is greater than the first modulation quality threshold, or
selecting the second transmission mode if the minimum modulation quality of the receiving node is less than the first modulation quality threshold.

8. The method of claim 7, wherein a modulation quality requirement of the second transmission mode is less than a modulation quality requirement of the first transmission mode.

9. The method of claim 6, further comprising:
storing mode transmission information for each of the plurality of transmission modes, wherein the transmission mode information comprises a first modulation quality threshold associated with a first mode and a second modulation quality threshold associated with a second transmission mode;
based on the information indicating the capability of the receiving node, comparing the minimum modulation quality of the receiving node to at least one of the first modulation quality threshold and the second modulation quality threshold; and
selecting the first transmission mode or the second transmission mode based on the step of comparing the minimum modulation quality of the receiving node to the at least one of the first modulation quality threshold and the second modulation quality threshold.

10. The method of claim 1, wherein obtaining the information indicating a capability of the receiving node comprises at least one of:
receiving at least a portion of the information from the receiving node,
receiving at least a portion of the information from a node other than the receiving node,
determining the capability of the receiving node based on a number of retransmissions of a previously transmitted signal sent to the receiving node, and
determining the capability of the receiving node based on a feedback signal received from the receiving node.

11. The method of claim 1, wherein the certain level of distortion comprises at least one of:
a value of allowable error-vector-magnitude (EVM);
a value of allowable Adjacent Channel Leakage Ratio (ACLR);
a value of allowable Intermodulation Distortion (IMD); and
a value of allowable frequency error.

12. The method of claim 1, wherein:
the transmitting node comprises a user equipment or other wireless device;
the receiving node comprises a network node; and
the signal is transmitted on an uplink from the user equipment or other wireless device to the network node.

13. The method of claim 1, wherein:
the transmitting node comprises a network node;
the receiving node comprises a user equipment or other wireless device; and
the signal is transmitted on a downlink from the network node to the user equipment or other wireless device.

14. The method of claim 1, wherein:
the transmitting node comprises a first user equipment or first wireless device; and
the receiving node comprises a second user equipment or second wireless device.

15. A method by a receiving node for adapting a reception mode based on a capability of a transmitting node, the method comprising:
obtaining information indicating the capability of the transmitting node to adjust a transmit mode to transmit signals having a certain level of distortion; and
receiving a signal from the transmitting node, the signal transmitted using a transmission mode selected based on the capability of the transmitting node.

16. The method of claim 15, further comprising:
based on the capability of the transmitting node to adjust the transmit mode to transmit signals having the certain level of distortion, selecting a reception mode from a plurality of reception modes, wherein each of the plurality of reception modes is associated with a respective one of a plurality of distortion levels; and
transmitting, to the transmitting node, an indication of the reception mode that is selected from the plurality of reception modes,
wherein the signal received from the transmitting node is received based on the reception mode that is selected.

17. The method of claim 16, wherein the reception mode that is selected by the receiving node corresponds to the transmission mode used by the transmission node, and wherein the transmission mode is associated with at least one transmitter setting that effects the certain level of distortion inserted into the transmitted signal.

18. The method of claim 17, wherein the at least one transmitter setting comprises at least one of:
an operating point of a power amplifier;
a transmission power level;
a maximum power reduction (MPR);
a modulation and coding (MCS) scheme; and
training sample or data.

19. The method of claim 16, wherein at least one of:
the signal received from the transmitting node is of a lower quality than a first previously received signal that was received according to a reception mode that is different from the reception mode selected from the plurality of reception modes,
the signal received using the reception mode selected from the plurality of reception modes is of a higher quality than a second previously received signal that was transmitted according to a reception mode that is different from the reception mode selected from the plurality of reception modes,
the signal received using the reception mode selected from the plurality of reception modes is received at a lower transmit power than a third previously received signal that was transmitted according to a reception mode that is different from the mode selected from the plurality of reception modes, and
the signal received using the reception mode selected from the plurality of reception modes is received at a higher transmit power than a fourth previously received signal that was transmitted according to a reception mode that is different from the reception mode selected from the plurality of reception modes.

20-29. (canceled)

30. A transmitting node for adapting a transmission mode based on a capability of a receiving node, the transmitting node adapted to:
obtain information indicating a capability of the receiving node to receive signals having a certain level of distortion; and
transmit a signal to the receiving node, the signal transmitted using a transmission mode selected based on the capability of the receiving node.

31-33. (canceled)
